(19) United States
(12) Patent Application Publication
(10) Pub. No.: US 2026/0276944 A1
(43) Pub. Date: Sep. 17, 2026

(54) OPTICAL MODULE AND WEARABLE DEVICE

(71) Applicant: Goertek Optical Technology (Qingdao) Co., Ltd., Shandong (CN)

(72) Inventors: Dasen Li, Shandong (CN); Benhua Liu, Shandong (CN); Bogang Zhao, Shandong (CN)

(73) Assignee: Goertek Optical Technology (Qingdao) Co., Ltd., Shandong (CN)

(21) Appl. No.: 19/163,934

(22) PCT Filed: Oct. 30, 2023
(86) PCT No.: PCT/CN2023/127712

§ 371 Date: Sep. 10, 2025

(30) Foreign Application Priority Data
Mar. 28, 2023 (CN) 202310319761.2
Oct. 25, 2023 (CN) 202311393410.2

(51) Int. Cl. G02B 7/12

(52) U.S. Cl. CPC G02B 7/12

(57) ABSTRACT

An optical module and a wearable device are disclosed. The optical module includes an imaging lens group, a first bracket, a lens barrel, an arc-shaped rack, a lead screw gear, and a driving member. The imaging lens group includes a first lens, having a beveled lens; the first lens is provided in the first bracket, and an outer wall of the lens barrel is provided with an arc-shaped groove; a lead screw gear includes a lead screw and a gear provided at one end of the lead screw, the lead screw is in transmission connection with the first bracket, and the gear forms meshing transmission with the arc-shaped rack; and the driving member forms meshing transmission with the arc-shaped rack.

### CROSS-REFERENCE TO RELATED APPLICATIONS

This application is a National Stage of International Application No. PCT/CN2023/127712, filed on Oct. 30, 2023, which claims priority to Chinese Patent Application No. 202310319761.2, filed on Mar. 28, 2023 and Chinese Patent Application No. 202311393410.2, filed on Oct. 25, 2023, all of which are hereby incorporated by reference in their entireties.

### TECHNICAL FIELD

Embodiments of the present disclosure relate to the field of optical imaging technology, and particularly to an optical module and a wearable device.

### BACKGROUND

Virtual Reality (VR) technology integrates computer, electronic information and simulation technologies. The fundamental implementation method involves computer-simulated virtual environments to provide users with immersive experiences. Due to variations in users' diopter levels, VR devices need to meet the needs of people with different diopter levels. Therefore, it is essential for the VR device to have a diopter adjustment function.

In the prior art, round lenses (without beveled edges) are adjusted to change the distance between lenses. A common approach involves rotating a circular adjustment ring to effect movement of the lens in the anterior-posterior position, so as to effect diopter adjustment. However, under the condition that the lenses have beveled edges, the traditional scheme of changing the position of the movable lens in the lens barrel by rotating the lens is not applicable.

The advantage of using beveled lenses in the existing VR device is that they provide clearance for the wearer's nose bridge and brow bone, which has led to increased adoption of the beveled lens in the VR device. Therefore, it is necessary to study the diopter adjustment schemes for optical modules that include beveled lenses.

### SUMMARY

An objective of the present disclosure is to provide new solutions for an optical module and a wearable device, which enables diopter adjustment when the lens in the optical module has a beveled edge.

In a first aspect, the present disclosure provides an optical module. The optical module includes:
an imaging lens group comprising at least a first lens which is a beveled lens;
a first bracket, the first lens being provided in the first bracket;
a lens barrel, the first bracket being movably provided in the lens barrel, an outer wall of the lens barrel being provided with an arc-shaped groove;
an arc-shaped rack, the arc-shaped rack being placed in the arc-shaped groove, an arc length L1 of the arc-shaped rack being less than an arc length L2 of the arc-shaped groove;
a lead screw gear comprising a lead screw and a gear provided at one end of the lead screw, the lead screw being in transmission connection with the first bracket, the gear forming meshing transmission with the arc-shaped rack; and
a driving member forming meshing transmission with the arc-shaped rack and configured for driving the arc-shaped rack to rotate so as to actuate the lead screw gear to rotate, the lead screw gear being capable of driving the first bracket, which in turn actuates the first lens to move along an axial direction of the lens barrel, so that the first lens is capable of matching a diopter of a target object.

Optionally, the lens barrel has a beveled region, and the arc-shaped rack has an opening; and in a case where an angle corresponding to the beveled region is ≥90°, an angle corresponding to the opening is ≥120°.

Optionally, the first bracket comprises a bracket body and an assembly ring;
the first lens is provided in the bracket body;
a pillar is provided on an edge of the bracket body along a circumferential direction thereof; and
the assembly ring extends through the pillar, is fixedly provided on one side of the bracket body, and is provided with a threaded hole thereon along a circumferential direction, an end of the lead screw away from the gear forming a transmission connection with the threaded hole.

Optionally, the pillar is provided in at least two;
the assembly ring is provided with a connection hole, which matches the pillar, along a circumferential direction, and the connection hole and the threaded hole are arranged in a staggered pattern; and
the assembly ring extends through the pillar and is fixedly connected to the bracket body via a circlip.

Optionally, the lead screw gear is provided in at least two.

Optionally, the optical module further comprises a protective cover, and the protective cover is located at an end of the lens barrel where the arc-shaped rack and the lead screw gear are provided, and covers the arc-shaped rack and the lead screw gear; and
the protective cover and the lens barrel are fixedly connected, and a plurality of connection points are provided therebetween.

Optionally, the optical module further comprises a screen bracket, which is provided on the protective cover; and
the screen bracket is provided with a display screen therein.

Optionally, the optical module further comprises a second lens and a second bracket, the second lens is provided in the second bracket, and the second bracket is fixedly provided at an end of the lens barrel away from the screen bracket.

Optionally, the optical module further comprises a third lens, which is fixedly provided in the lens barrel and is located on a side close to the screen bracket, and the first lens is movably provided between the second lens and the third lens.

Optionally, the second lens, the first lens, and the third lens are arranged sequentially at intervals along an axial direction of the lens barrel; wherein the second lens is a beveled lens, and a beveled edge side of the second lens corresponds to a beveled edge side of the first lens.

Optionally, the driving member comprises a bevel gear and a compound gear;
the compound gear comprises a first linkage gear and a second linkage gear, which are coaxially provided; wherein the first linkage gear is a conical gear;
the bevel gear forms meshing transmission with the first linkage gear; and
the second linkage gear forms meshing transmission with the arc-shaped rack.

Optionally, the optical module has a back focal length (BFL) of 2 mm to 5 mm.

In a second aspect, the present disclosure provides a wearable device. The wearable device includes:
a housing; and
the optical module according to the first aspect, the optical module being provided in the housing.

Optionally, the housing is a spectacle frame which is provided with two lens frames, the optical module are provided as two, and two optical modules are respectively provided in the two lens frames.

The beneficial effects of the present disclosure are:

Embodiments of the present disclosure provide an optical module. By introducing a rotatable arc-shaped rack with an opening structure on the outer wall of the lens barrel, a transmission cooperation relationship is formed among the arc-shaped rack, the lead screw gear, and the driving member, which enables the beveled first lens inside the lens barrel to move translationally along the axial direction of the lens barrel, thereby achieving diopter adjustment under the condition that the lens in the optical module is beveled, and facilitating expanded application of beveled lenses in the diopter-adjustable optical modules.

Other features and advantages of the present specification will become apparent from the following detailed description of exemplary embodiments of the present specification with reference to the accompanying drawings.

### BRIEF DESCRIPTION OF THE DRAWINGS

The accompanying drawings, which are incorporated in the specification and constitute a part of the specification, illustrate embodiments of the present specification and, together with the description thereof, serve to explain the principles of the present specification.

FIG. 1 is an exploded structural schematic view of an optical module provided by an embodiment of the present disclosure;

FIG. 2 is a first structural schematic view of the optical module provided by an embodiment of the present disclosure;

FIG. 3 is a second structural schematic view of the optical module provided by an embodiment of the present disclosure;

FIG. 4 is a third structural schematic view of the optical module provided by an embodiment of the present disclosure;

FIG. 5 is a structural schematic view of a first bracket of the optical module provided by an embodiment of the present disclosure;

FIG. 6 is a structural schematic view of a first lens of the optical module provided by an embodiment of the present disclosure;

FIG. 7 is a structural schematic view of a lens barrel of the optical module provided by an embodiment of the present disclosure;

FIG. 8 is a structural schematic view of an arc-shaped rack of the optical module provided by an embodiment of the present disclosure;

FIG. 9 is a structural schematic view of an assembly ring of the optical module provided by an embodiment of the present disclosure;

FIG. 10 is a structural schematic view of a lead screw gear of the optical module provided by an embodiment of the present disclosure;

FIG. 11 is a structural schematic view of a protective cover of the optical module provided by an embodiment of the present disclosure;

FIG. 12 is a first structural schematic view of the optical module without the screen bracket provided by an embodiment of the present disclosure;

FIG. 13 is a second structural schematic view of the optical module without the screen bracket provided by an embodiment of the present disclosure;

FIG. 14 is a structural schematic view of a second bracket of the optical module provided by an embodiment of the present disclosure;

FIG. 15 is a structural schematic view of a second lens of the optical module provided by an embodiment of the present disclosure;

FIG. 16 is a structural schematic view of a compound gear of the optical module provided by an embodiment of the present disclosure.

### DESCRIPTION OF REFERENCE SIGNS

1. First lens; 101. Lens beveled edge A; 2. First bracket; 201. Bracket body; 202. Assembly ring; 203. Pillar; 204. Threaded hole; 205. Connection hole; 3. Lens barrel; 301. Beveled region; 4. Arc-shaped rack; 401. Opening; 5. Lead screw gear; 501. Lead screw; 502. Gear; 6. Driving member; 601. Bevel gear; 602. Compound gear; 603. First linkage gear; 604. Second linkage gear; 7. Circlip; 8. Protective cover; 9. Second lens; 901. Lens beveled edge B; 10. Second bracket; 11. Third lens; 12. Screen bracket; 13. Connection point.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

According to an aspect of embodiments of the present disclosure, an optical module is provided, which is applicable to wearable devices. The wearable devices include, for example, a head-mounted display (HMD). The head-mounted display includes, for example, a VR head-mounted device. The VR head-mounted device may include VR glasses or VR helmets, among other forms, to which the embodiments of the present disclosure are not specifically limited.

In VR product design, taking VR glasses as an example, to avoid the nose bridge, eyebrow bone and other areas of the user when the product is worn, and to improve the wearing comfort, the lens applied in the optical module can be subjected to beveling treatment, so that the lens forms a non-circular structure, and the corresponding lens barrel also forms a non-circular shape. The beveled lens used in the VR glasses is an irregular shape.

Although the use of beveled lenses in VR products enhances wearing comfort, their optical design also introduces drawbacks. For instance, due to significant variations in users' vision, it is necessary to adjust the spacing between lenses or the distance between lenses and the display screen to achieve diopter adjustment. However, beveled lenses have irregular shapes after beveling, so that the lens cannot be actuated to rotate by a traditional adjusting component and the rotating motion cannot be converted into the motion along the optical axis direction, thus failing to meet the use requirements of people with different vision.

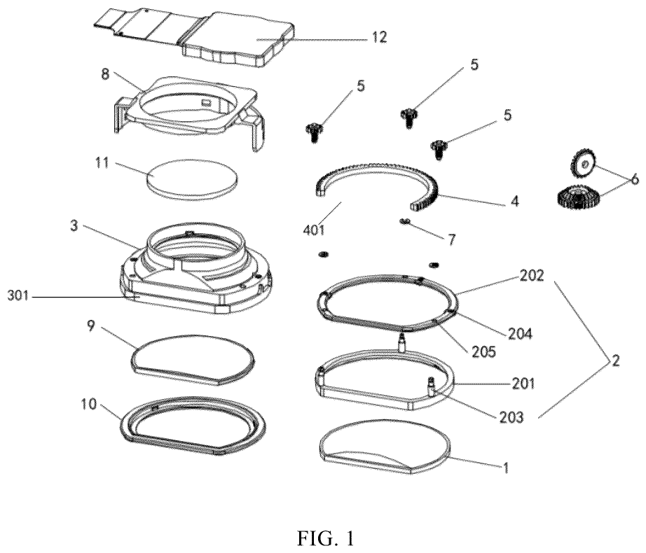

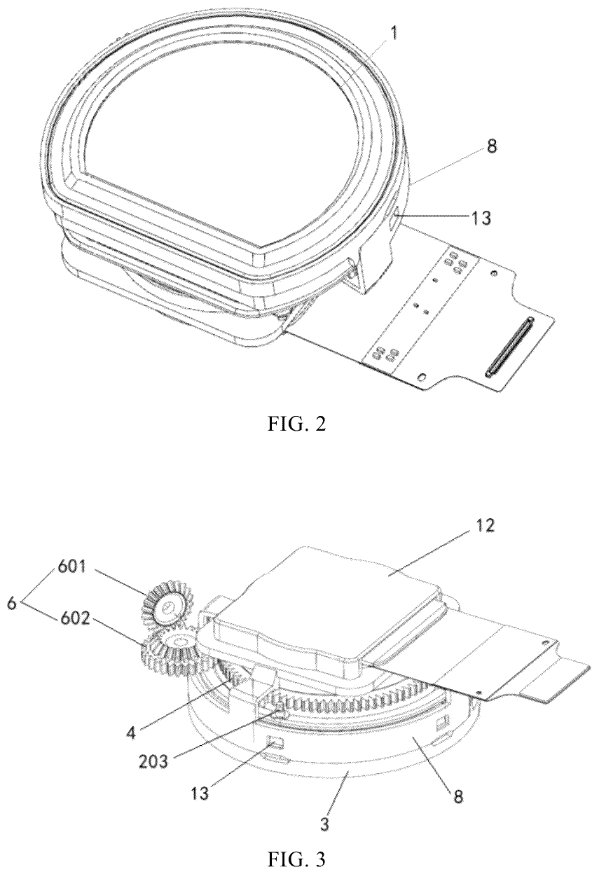

The optical module provided by the embodiments of the present disclosure, as shown in FIGS. 1 to 4, includes:
an imaging lens group, a first bracket 2, a lens barrel 3, an arc-shaped rack 4, a lead screw gear 5, and a driving member 6.

Specifically, the imaging lens group includes at least a first lens 1, which is a beveled lens. The first lens 1 is provided in the first bracket 2. The first bracket 2 is movably provided in the lens barrel 3. An outer wall of the lens barrel 3 is provided with an arc-shaped groove. The arc-shaped rack 4 is placed in the arc-shaped groove, and an arc length L1 of the arc-shaped rack 4 is less than an arc length L2 of the arc-shaped groove.

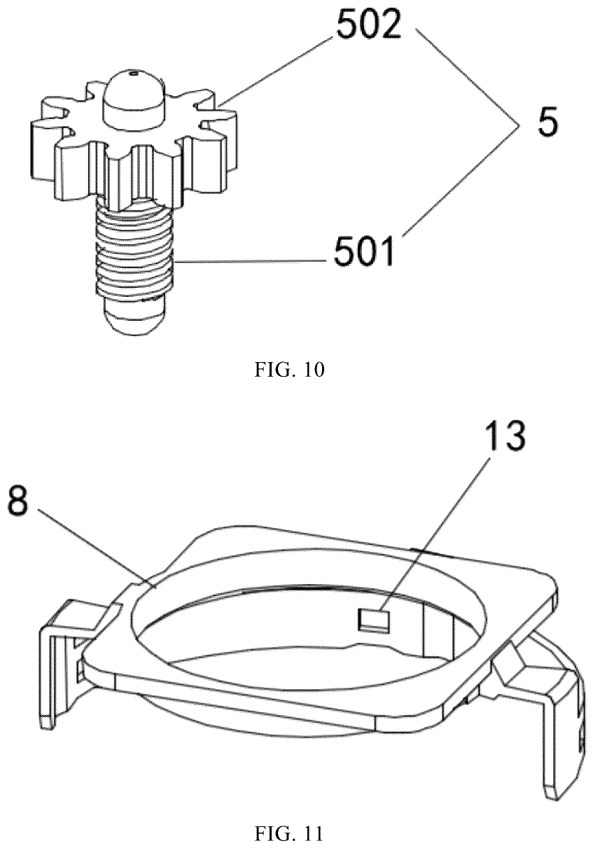

As shown in FIG. 10, the lead screw gear 5 includes a lead screw 501 and a gear 502 provided at one end of the lead screw 501. The end of the lead screw 501 away from the gear 502 is in transmission connection with the first bracket 2, and the gear 502 forms meshing transmission with the arc-shaped rack 4.

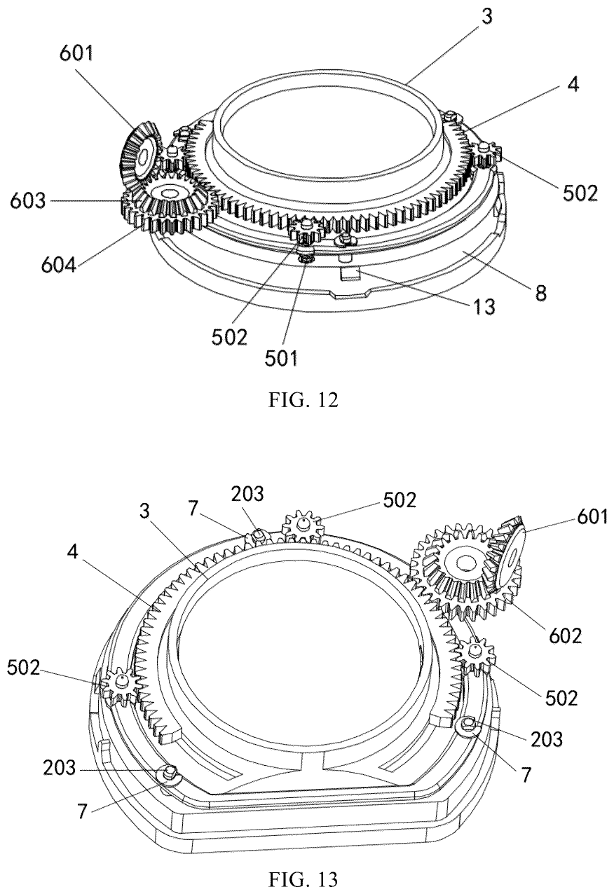

As shown in FIGS. 12 and 13, the driving member 6 forms meshing transmission with the arc-shaped rack 4 and is configured for driving the arc-shaped rack 4 to rotate, thereby actuating the lead screw gear 5 to rotate. The lead screw gear 5 can drive the first bracket 2 to actuate the first lens 1 to move along the axial direction of the lens barrel 3, enabling the first lens 1 to match the diopter of a target object.

In the optical module provided by the above embodiment of the present disclosure, the first lens 1 is provided in the lens barrel 3 and is configured as a movable lens. The movable design of the first lens 1 enables diopter adjustment of the entire optical module, allowing adaptation to users' diopter.

For the optical module provided by the above embodiment of the present disclosure, the first lens 1 may be a beveled lens. This achieves diopter adjustment while the first lens 1 has a beveled edge.

When using the optical module of the embodiment of the present disclosure, if focus adjustment is required, the driving member 6 can drive the arc-shaped rack 4 sleeved on the outer wall of the lens barrel 3 to rotate. Since the arc-shaped rack 4 and the gear 502 of the lead screw gear 5 form a tooth-to-tooth meshing transmission relationship, the rotation of the arc-shaped rack 4 may drive the gear 502 to rotate accordingly, and then the gear 502 drives the coaxially arranged lead screw 501 to rotate. As the lead screw 501 is rotated, the first bracket 2 carrying the first lens 1 moves linearly along the lead screw 501, thereby changing the position of the first lens 1 in the lens barrel 3.

In other words, the rotational motion of the driving member 6 is transmitted to the arc-shaped rack 4, and the rotational motion of the arc-shaped rack 4 relative to the lens barrel 3 is further transmitted to the lead screw gear 5. Ultimately, the aforementioned series of rotational motions are converted into linear motion of the first bracket 2 along the axial direction of the lens barrel 3, so that the first lens 1 can move forward and backward within the lens barrel 3 to ultimately match the users' diopter. This provides a new structural design for diopter adjustment of the beveled lenses.

Specifically, an arc-shaped groove is provided on the outer wall of the lens barrel 3, as shown in FIG. 1, and is configured for mounting the arc-shaped rack. To reduce assembly difficulty and accommodate arc-shaped racks with openings of different sizes, the arc length L1 of the arc-shaped rack 4 may be designed to be less than the arc length L2 of the arc-shaped groove.

In conventional VR optical designs, most solutions adopt a fixed-focus configuration where the imaging lens group maintains predetermined spacing between lenses. This results in an optical module with non-adjustable diopter. Furthermore, to realize the diopter adjustment function, a movable lens is usually provided in the imaging lens group in the current technology. The movable lens is generally circular, and can realize linear motion along the optical axis direction of the movable lens while rotating, so as to realize position adjustment of the movable lens, thereby realizing adjustment of the distance between the movable lens and the fixed lens in the optical module, and realizing diopter adjustment of the optical module. However, the key point of this diopter adjustment solution is that the movable lens in the optical module must be circular, which is obviously not applicable to the beveled lenses. This is because the beveled lenses are not circular in shape and cannot be controlled to move in a straight line along their optical axis during rotation. In other words, the traditional optical module diopter adjustment solution cannot be applied to the beveled lenses.

It is important to emphasize that in the optical module provided by the above embodiment of the present disclosure, the designed focus adjustment (diopter adjustment) solution is highly suitable for the beveled lenses.

Of course, the technical solution provided by the embodiment of the present disclosure is not limited to the shape of movable lenses actually. In addition to the aforementioned beveled lenses, it is also suitable for the circular lenses. In other words, the focus adjustment solution for the optical module provided by the embodiment of the present disclosure imposes no specific requirements on the shape of lenses, making it widely applicable.

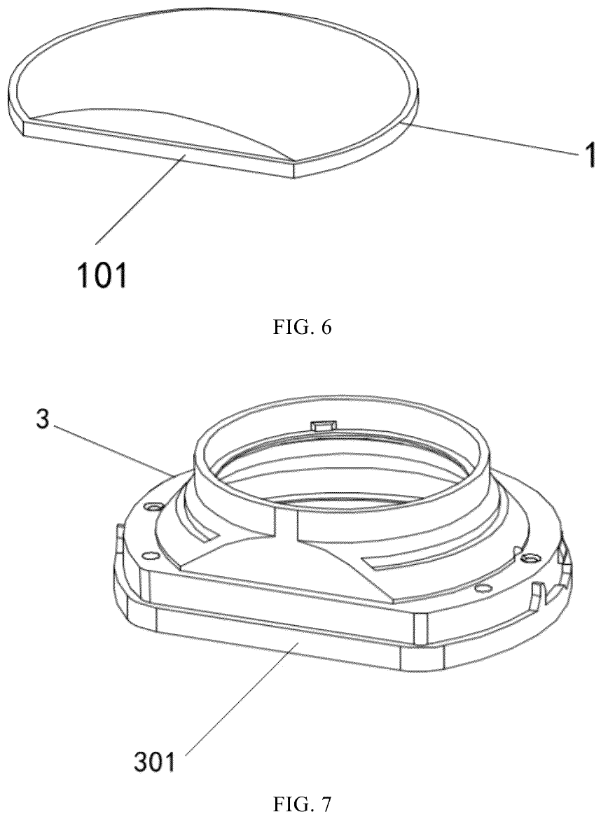

In the above-described embodiment of the present disclosure, the first lens 1 is a beveled lens. Referring to FIG. 6, considering that the first lens 1 is used as a movable lens in the entire optical module and has an irregular outer shape with a beveled edge, the first lens 1 is designed not to perform rotational motion but to perform linear motion along the axial direction of the lens barrel 3 (i.e., along its own optical axis) under the support of the first bracket 2. In other words, the first lens 1 with the beveled edge only performs linear motion under drive, which imposes no restrictions on the shape of the first lens 1. With the change of position of the first lens 1 in the lens barrel 3, the free matching of the diopter can be realized.

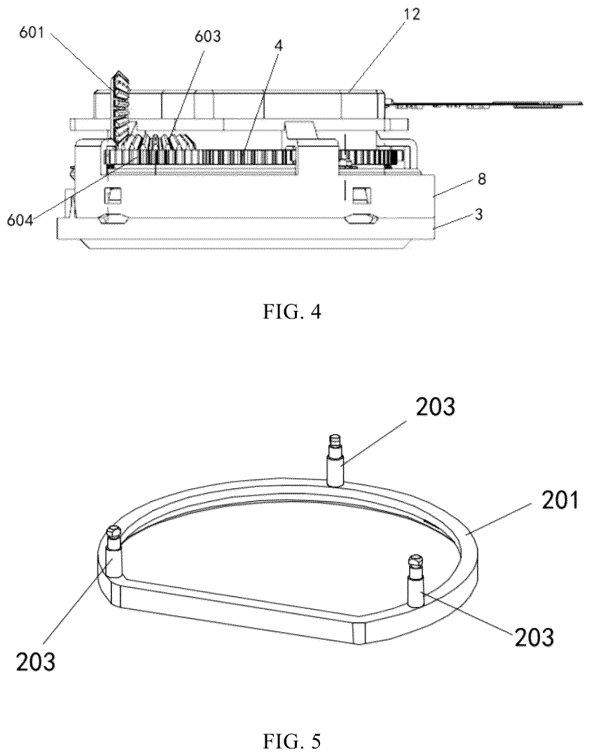

In the above-described embodiment of the present disclosure, the first lens 1 is a beveled lens, which has a lens beveled edge A 101, as shown in FIG. 6, causing the first lens 1 to appear non-circular in shape, i.e., an irregular shape. The first bracket 2 is used to support the first lens 1 and is designed with a surface that matches the above lens beveled edge A 101, as shown in FIG. 5. The first bracket 2 may protect the first lens 1 and facilitates its assembly within the lens barrel 3 while controlling its movement.

In the optical module provided in the embodiments of the present disclosure, the first lens 1 with the beveled edge can move linearly along the axial direction of the lens barrel 3 within a predetermined range. Thus, it is possible to adjust the position of the first lens 1 within the lens barrel 3, thereby enabling diopter adjustment and accurately matching the user's diopter.

The optical module provided by the embodiments of the present disclosure can be used for people with different diopters, and thus can enhance the user experience for those wearing glasses. Users do not need to wear glasses and can match their own diopter through the diopter adjustment function of the optical module, which is beneficial for improving the user's visual experience.

Specifically, the rotation of the driving member 6 can be electrically driven by a drive mechanism.

Of course, the rotation of the driving member 6 can also be manually driven. The present disclosure does not impose specific restrictions on the drive method for rotating the driving member 6.

It should be emphasized that the optical focusing solution provided by the embodiments of the present disclosure is particularly suitable for lens barrels with large beveled lenses. However, it is also applicable to conventional lens barrels with circular lenses, demonstrating a broad scope of application.

In the optical module provided by the embodiments of the present disclosure, the imaging lens group includes at least one movable lens (the aforementioned first lens 1), which can be used to adjust the diopter; and the imaging lens group also includes one or more fixed lenses.

For example, as shown in FIG. 1, the imaging lens group of the optical module includes three lenses, one of which is a movable lens and a beveled lens (as shown in FIG. 1 as the first lens 1), while the remaining two lenses are fixed lenses.

It should be noted that in the optical module of the embodiments of the present disclosure, the number of lenses can be flexibly adjusted according to specific needs.

Additionally, optical components such as a beam splitter, phase retarder, and polarization reflector may also be provided within the optical module, so as to form a folded optical path (pancake) by the whole optical module. The light used for imaging is reflected between the folded optical paths, which may extend the propagation path of light and facilitate final clear imaging. The folded optical path design may reduce the size of the optical module along the optical axis and the weight of the optical module, which facilitates the light and thin design of VR devices and may improve wearing comfort.

Specifically, the beam splitter, for example, is a semi-transparent and semi-reflective device that allows part of the light to pass through and reflects the remaining part. The reflectance of the beam splitter is, for example, 47% to 53%.

Specifically, the phase retarder may be a quarter-wave plate. Of course, the phase retarder may also be configured as other phase delay plates, such as half-wave plates, as needed. The phase retarder may be used to alter the polarization state of light, such as converting linearly polarized light into circularly polarized light or vice versa.

Specifically, the polarization reflective element is a polarizing reflector that reflects horizontally linearly polarized light while transmitting vertically linearly polarized light, or the polarization reflective elements are some other polarizing reflectors that reflect linearly polarized light at any specified angle while transmitting linearly polarized light oriented perpendicular to said angle.

In the embodiments of the present disclosure, the phase retarder and the polarization reflective element cooperate, which may analyze and transmit light beams.

Specifically, the beam splitter, phase retarder, and polarization reflective element can be flexibly disposed within the lens group, but it needs to be ensured that the phase retarder needs to be located between the beam splitter and the polarization reflective element.

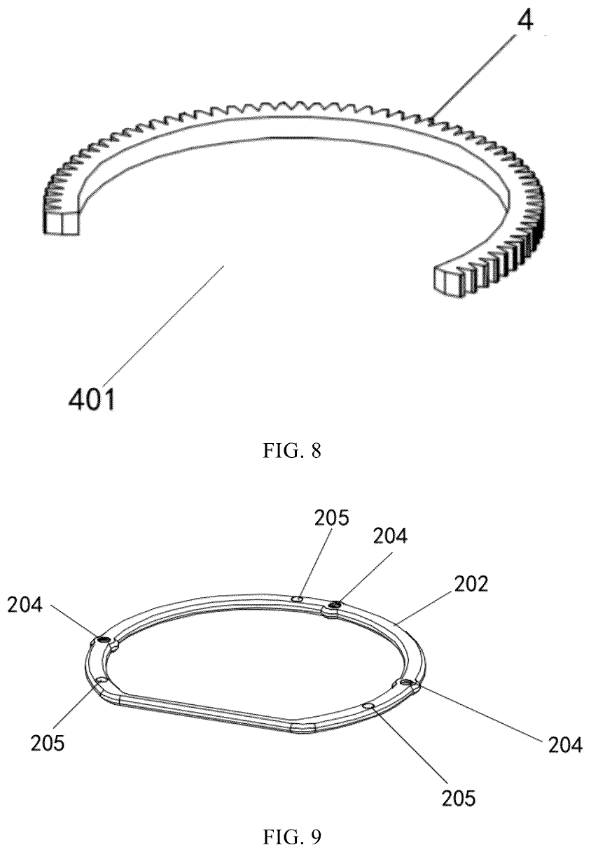

In some examples of the present disclosure, as shown in FIG. 7, the lens barrel 3 has a beveled region 301, and as shown in FIG. 8, the arc-shaped rack 4 has an opening 401; when the angle corresponding to the beveled region 301 is ≥90°, the angle corresponding to the opening 401 is ≥120°.

According to the above example, the lens barrel 3 also has a non-circular structure. In this way, it is possible to avoid interference with areas such as the wearer's nose bridge and brow bone, and thus help to improve wearing comfort. Specifically, the lens barrel 3 includes the beveled region 301.

For example, when designing an optical module, if the eye relief is 12 mm, the aperture size of the lens barrel 3 is 53 mm, and the interpupillary distance (IPD) is ≥60 mm, the angle of the beveled region 301 of the lens barrel 3 can be set to ≥90°, and at this time, the angle corresponding to the opening 401 of the arc-shaped rack 4 can be set to ≥120°. On this basis, it is possible to adapt the diopter adjustment range for most users. Moreover, the above parameters such as the interpupillary distance and the aperture size of the lens barrel 3 are also suitable for most users.

Of course, the angle of the beveled region 301 of the lens barrel 3 and the angle of the opening 401 of the arc-shaped rack 4 may also be adjusted according to different user groups, and the embodiment of the present disclosure includes but is not limited to the above parameter ranges.

In some examples of the present disclosure, as shown in FIG. 5, the first bracket 2 includes a bracket body 201 and an assembly ring 202. The first lens 1 is provided in the bracket body 201. A pillar 203 is provided on an edge of the bracket body 201 along a circumferential direction thereof. Referring to FIG. 9, the assembly ring 202 extends through the pillar 203, is fixedly provided on one side of the bracket body 201, and is provided with a threaded hole 204 thereon along a circumferential direction, and an end of the lead screw 501 away from the gear 502 forms a transmission connection with the threaded hole 204.

As shown in FIG. 5, the bracket body 201 of the first bracket 2 is in a ring-shaped structure with a beveled edge matching the first lens 1, and includes a lens mounting position for installing the first lens 1.

The first lens 1, for example, is fixed in the lens mounting position by adhesive bonding.

The shape and size of the lens mounting position need to be adapted to the first lens 1 so as to better accommodate and protect the first lens 1.

The first lens 1 is fixed within the bracket body 201, integrating the first lens 1 with the first bracket 2. As the first bracket 2 moves, the first lens 1 can move synchronously, meaning that, the first bracket 2 can cause the first lens 1 to move.

As shown in FIG. 5, the pillar 203 is also disposed on the edge of the bracket body 201, that is, in areas outside the lens mounting position. The pillars 203 and the bracket body 201 may be integrally designed, ensuring high connection strength therebetween.

Specifically, the pillar 203 is used to connect the assembly ring 202, and secure it to one side of the bracket body 201, integrating the bracket body 201 with the assembly ring 202. In this basis, the first bracket 2 may form a transmission connection with the lead screw gear 5 via the assembly ring 202. The rotational motion of the driving member 6 can be converted into linear motion of the assembly ring 202 along the lead screw 501 of the lead screw gear 5, such that the first bracket 2 may cause the first lens 1 to move linearly along the axial direction of the lens barrel 3.

Optionally, as shown in FIG. 5, the pillar 203 is provided in at least two. The assembly ring 202 is provided with a connection hole 205, which matches the pillar 203, along a circumferential direction, and the connection hole 205 and the threaded hole 204 are arranged in a staggered pattern, see FIG. 9. The assembly ring 202 may pass through the pillar 203 and is fixedly connected to the bracket body 201 via a circlip 7, see FIG. 13.

To enhance connection stability, multiple pillars 203 may be installed on the bracket body 201. The assembly ring 202 must include connection holes 205 matching the pillars 203, as shown in FIG. 5.

When assembling the assembly ring 202 on one side of the bracket body 201, the connection hole 205 of the assembly ring 202 needs to pass through the corresponding pillars 203, such that the assembly ring 202 can be assembled with the bracket body 201.

In the above optional example, referring to FIG. 1, the circlip 7 is a fixture that is a thin ring structure with a notch on the edge. The circlip 7 may be fixed in the circumferential direction of the pillar 203, so that the connection strength between the assembly ring 202 and the bracket body 201 is better.

Additionally, the circlip 7 offers simple fixation and easy disassembly/assembly, facilitating subsequent maintenance and repairs.

For example, the number of pillars 203 may be set to three, with each pillar 203 uniformly distributed along the edge region of the bracket body 201. On one side of the bracket body 201, the number of pillars 203 is set to three, which facilitates the formation of a stable connection between the bracket body 201 and the assembly ring 202, thereby enhancing reliability.

A threaded hole 204 is further provided on the assembly ring 202. The threaded hole 204 is configured to form a transmission connection with the lead screw 501 of the lead screw gear 5. When the lead screw 501 rotates, the assembly ring 202 is in driving engagement with the lead screw 501 through the threaded hole 204. Thus, the assembly ring 202 can move linearly along the lead screw 501. Since the assembly ring 202 is connected to the bracket body 201, the entire first bracket 2 can carry the first lens 1 to move linearly in the lens barrel 3.

Because the assembly ring 202 not only forms a fixed connection with the bracket body 201, but also forms a transmission connection with the lead screw 501 of the lead screw gear 5, the connection hole 205 should be staggered from the threaded hole 204.

In some examples of the present disclosure, referring to FIGS. 1 and 12-13, the lead screw gear 5 is provided in at least two.

As a preferred mode of the present disclosure, the lead screw gear 5 may be provided in three. In this way, when the first bracket 2 carries the first lens 1 to move along the axial direction of the lens barrel 3, it is not easy for the first lens 1 to be inclined and stuck, making the movement relatively stable and reliability relatively high. Moreover, the cost is not excessively increased and the structure of the device is not complicated.

In some examples of the present disclosure, see FIGS. 1 and 11, the optical module further includes a protective cover 8, and the protective cover 8 is located at an end of the lens barrel 3 where the arc-shaped rack 4 and the lead screw gear 5 are provided, and covers the arc-shaped rack 4 and the lead screw gear 5; and the protective cover 8 and the lens barrel 3 are fixedly connected, and a plurality of connection points 13 are provided therebetween.

Specifically, the protective cover 8 may serve to secure and protect the arc-shaped rack 4 and the lead screw gear 5.

The protective cover 8 may be fixedly connected to the lens barrel 3 by means of snap-fit engagement and/or adhesive bonding, so that the protective cover 8 is firmly connected to the lens barrel 3.

Referring to FIG. 3, when the protective cover 8 is fixedly connected with the lens barrel 3, for example, three connection points 13 can be designed, which can also increase the connection stability of the protective cover 8 and the lens barrel 3, so as to prevent the protective cover 8 and the lens barrel 3 from being separated from each other due to an external force.

In some examples of the present disclosure, referring to FIGS. 1 and 3, the optical module further includes a screen bracket 12, which is provided on the protective cover 8; and the screen bracket 12 is provided with a display screen therein (the display screen is not shown in figures).

The screen bracket 12 may be fixed to the protective cover 8 by means of adhesive bonding, for example.

The screen bracket 12 includes, for example, a supporting body and an electric control part connected to the supporting body. The above display screen is accommodated in the supporting body. The electric control part is used for forming electric connection with the display screen accommodated in the supporting body.

In some examples of the present disclosure, referring to FIGS. 1 and 14-15, the optical module further includes a second lens 9 and a second bracket 10, the second lens 9 is provided in the second bracket 10, and the second bracket 10 is fixedly provided at an end of the lens barrel 3 away from the screen bracket 12.

In the optical module provided by the embodiment of the present disclosure, the imaging lens group is not only provided with the above first lens 1, but also provided with a second lens 9, which is a fixed lens.

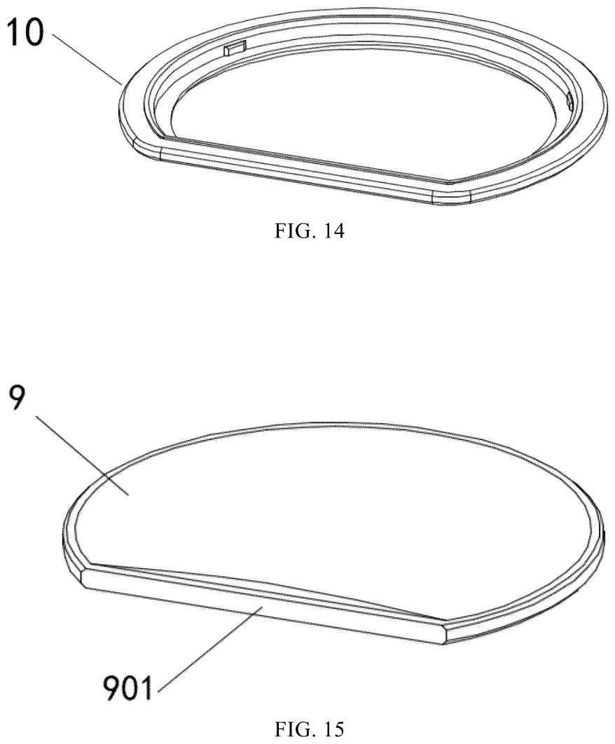

Referring to FIG. 14, the second bracket 10 is used for bearing the second lens 9, and may fix it at one end of the lens barrel 3 close to the human eye. The second bracket 10 may serve to protect the second lens 9 and facilitate assembly thereof.

Referring to FIG. 15, since the second lens 9 has a lens beveled edge B 901, the side of the corresponding second bracket 10 has a beveled surface, and referring to FIG. 14, an assembly area for assembling the second lens 9 is formed in the second bracket 10.

The second lens 9 may, for example, be bonded and fixed to the assembly area of the second bracket 10. The second bracket 10 is fixedly provided at one end of the lens barrel 3. Further, the second lens 9 may be a lens on the side close to the human eye, which is fixed to ensure the imaging quality and the comfort of the user when viewing the image.

By adjusting the position of the first lens 1 in the lens barrel 3, it is possible to adjust the distance between the first lens 1 and the second lens 9, so as to realize a zooming scheme by controlling the movement of the first lens 1 relative to the second lens 9 on the basis of ensuring the imaging quality.

Referring to FIG. 7, the lens barrel 3 is, for example, a hollow structure capable of accommodating an optical device such as a lens, and has a first end and a second end opposite to each other. The first end may be provided with a lens mounting hole for assembling the second lens 9. Specifically, the second lens 9 is fixedly provided on the lens barrel 3 through the second bracket 10. The first end of the lens barrel 3 is, in use, for example, designed to be located on the side close to the human eye.

The lens barrel 3 also has, for example, a second end, which is disposed opposite to the first end. Specifically, when the first end faces towards the human eye, the second end is far away from the human eye and is located at one side of the optical module where the display screen is provided. On this basis, the display screen is fixed to the second end of the lens barrel 3 through the screen bracket 12.

In some examples of the present disclosure, referring to FIG. 1 and FIGS. 12-13, the optical module further includes a third lens 11, which is fixedly provided in the lens barrel 3 and is located on a side close to the screen bracket 12, and the first lens 1 is movably provided between the second lens 9 and the third lens 11.

The third lens 11 is fixed inside the lens barrel 3 and is located on the side of the first lens 1 away from the second lens 9. The third lens 11 is closer to the display screen side. In order to transmit the light emitted from the display screen as much as possible, the third lens 11 may be a circular lens.

The first lens 1, the second lens 9, and the third lens 11 are located on the same optical axis.

The second lens 9, the first lens 1, and the third lens 11 are arranged in sequence at intervals along the axial direction of the lens barrel 3; wherein, the second lens 9 is a beveled lens, and the beveled edge side of the second lens 9 corresponds to the beveled edge side of the first lens 1.

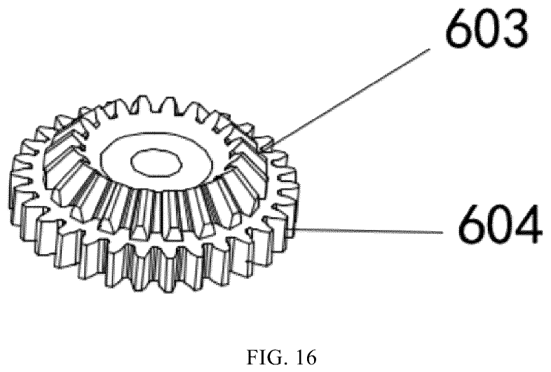

In some examples of the present disclosure, referring to FIG. 1 and FIGS. 12-13, the driving member 6 includes a bevel gear 601 and a compound gear 602; referring to FIG. 16, the compound gear 602 includes a first linkage gear 603 and a second linkage gear 604, which are coaxially provided; wherein the first linkage gear 603 is a conical gear; the bevel gear 601 forms meshing transmission with the first linkage gear 603; and the second linkage gear 604 forms meshing transmission with the arc-shaped rack 4.

In the embodiment of the present disclosure, the driving member 6 configured for gear-driven transmission, and includes two gear members, which are simple in transmission connection, small in size, space-saving, and good in transmission stability.

In some examples of the present disclosure, the optical module has a back focal length BFL of 2 mm to 5 mm.

The optical module provided by the embodiment of the present disclosure may be, for example, a folded optical path structure including a plurality of lenses, and the back focal length BFL in the above example represents the distance from the display screen to the last lens. The optical module provided by the embodiment of the present disclosure can have a smaller back focal length under the condition that the folded optical path includes three lenses, so that a better imaging effect can be realized on the basis of the light and thin design of the optical module.

In a specific example of the present disclosure, referring to FIGS. 1-4, the optical module includes an imaging lens group, a first bracket 2, a lens barrel 3, an arc-shaped rack 4, a lead screw gear 5, and a driving member 6; wherein, the imaging lens assembly includes a first lens 1, a second lens 9, and a third lens 11;
the first lens 1 is provided in the first bracket 2, the first bracket 2 is movably provided in the lens barrel 3, and the lens barrel 3 has a beveled region 301; the arc-shaped rack 4 has an opening 401, the angle corresponding to the opening 401 is set to ≥120° if the angle corresponding to the beveled region 301 is ≥90°, and the arc-shaped rack 4 is sleeved on the outer wall of the lens barrel 3; the lead screw gear 5 includes a lead screw 501 and a gear 502 provided at one end of the lead screw 501, an end of the lead screw 501 away from the gear 502 is in transmission connection with the first bracket 2, and the gear 502 forms meshing transmission with the arc-shaped rack 4; the driving member 6 forms meshing transmission with the arc-shaped rack 4 and is configured for driving the arc-shaped rack 4 to rotate so as to actuate the lead screw gear 5 to rotate, the lead screw gear 5 is capable of driving the first bracket 2 to actuate the first lens 1 to move along an axial direction of the lens barrel 3, so that the first lens 1 is capable of matching a diopter of a target object;
wherein, the first bracket 2 includes a bracket body 201 and an assembly ring 202; the first lens 1 is provided in the bracket body 201; three pillars 203 are provided on an edge of the bracket body 201 along a circumferential direction thereof; and the assembly ring 202 extends through each pillar 203, is fixedly provided on one side of the bracket body 201, and is provided with a threaded hole 204 thereon along a circumferential direction, and an end of the lead screw 501 away from the gear 502 forms a transmission connection with the threaded hole 204; the lead screw gear is provided as three;
the assembly ring 202 is provided with connection holes, which match each pillar 203, along a circumferential direction, and the connection holes 205 and the threaded holes 204 are arranged in a staggered pattern; and the assembly ring 202 extends through the pillar 203 and is fixedly connected to the bracket body via a circlip 7;
the optical module further includes a protective cover 8, and the protective cover 8 is located at an end of the lens barrel 3 where the arc-shaped rack 4 and the lead screw gear 5 are provided, and covers the arc-shaped rack 4 and the lead screw gear 5; and the protective cover 8 and the lens barrel 3 are fixedly connected, and three connection points 13 are provided;
the optical module further includes a screen bracket 12, which is fixedly provided on the protective cover 8, and the screen bracket 12 is provided with a display screen therein;
the optical module further includes a second bracket 10, the second lens 9 is provided in the second bracket 10, and the second bracket 10 is fixedly provided at an end of the lens barrel 3 away from the screen bracket 12; the third lens 11 is fixedly provided in the lens barrel 3 and is located on a side close to the screen bracket 12, and the first lens 1 is movably provided between the second lens 9 and the third lens 11; the second lens 9, the first lens 1, and the third lens 11 are arranged sequentially at intervals along an axial direction of the lens barrel 3; wherein the second lens 9 is a beveled lens, and a beveled edge side of the second lens 9 corresponds to a beveled edge side of the first lens 1;
wherein, the driving member 6 includes a bevel gear 601 and a compound gear 602; the compound gear 602 includes a first linkage gear 603 and a second linkage gear 604, which are coaxially provided; wherein the first linkage gear 603 is a conical gear; the bevel gear 601 forms meshing transmission with the first linkage gear 603; and the second linkage gear 604 forms meshing transmission with the arc-shaped rack 4.

The optical module provided by the above examples of the present disclosure achieves diopter adjustment under the condition that the lens in the optical module has been beveled, and facilitates expanded application of the beveled lens in the diopter-adjustable optical module.

According to another aspect of an embodiment of the present disclosure, a wearable device is further provided, which includes a housing and the optical module as described above, and the optical module is provided in the housing.

The wearable device is, for example, a VR headset, including VR glasses or a VR helmet, which is not specifically limited in the embodiments of the present disclosure.

In one example, the housing is a spectacle frame which is provided with two lens frames; the optical module are provided as two, and two optical modules are respectively provided in the two lens frames.

The specific implementation of the wearable device in the embodiments of the present disclosure may refer to the above embodiments of the optical module, and therefore has at least all the beneficial effects brought about by the technical solutions of the above embodiments, which are not repeated herein.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
an imaging lens group comprising at least a first lens having a beveled lens;
a first bracket, with the first lens positioned therein;
a lens barrel, with the first bracket movably positioned therein, an outer wall of the lens barrel being provided with an arc-shaped groove;
an arc-shaped rack positioned in the arc-shaped groove, an arc length L1 of the arc-shaped rack being less than an arc length L2 of the arc-shaped groove;
a lead screw gear comprising a lead screw and a gear provided at one end of the lead screw, the lead screw being in a transmission connection with the first bracket, the gear being engaged in a meshing transmission with the arc-shaped rack; and
a driving member engaged in a meshing transmission with the arc-shaped rack and configured for driving the arc-shaped rack to rotate to actuate the lead screw gear to rotate, the lead screw gear being configured for driving the first bracket, thereby actuating the first lens to move along an axial direction of the lens barrel, so that the first lens is configured to match a diopter of a target object.

2. The optical module according to claim 1, wherein the lens barrel has a beveled region, and the arc-shaped rack has an opening; and
when an angle corresponding to the beveled region is ≥90°, an angle corresponding to the opening is ≥120°.

3. The optical module according to claim 1, wherein the first bracket comprises a bracket body and an assembly ring;
the first lens is provided in the bracket body;
a pillar is provided on an edge of the bracket body along a circumferential direction thereof; and
the assembly ring extends through the pillar, is fixedly provided on one side of the bracket body, and is provided with a threaded hole thereon along a circumferential direction, with an end of the lead screw away from the gear for forming a transmission connection with the threaded hole.

4. The optical module according to claim 3, wherein the pillar is provided in at least two;
the assembly ring is provided with a connection hole, which matches the pillar, along a circumferential direction, and the connection hole and the threaded hole are arranged in a staggered pattern; and
the assembly ring extends through the pillar and is fixedly connected to the bracket body via a circlip.

5. The optical module according to claim 1, wherein the lead screw gear is provided at least two.

6. The optical module according to claim 1, wherein the optical module further comprises a protective cover, and the protective cover is located at an end of the lens barrel where the arc-shaped rack and the lead screw gear are provided, configured for coverings the arc-shaped rack and the lead screw gear; and
the protective cover and the lens barrel are fixedly connected, and a plurality of connection points are provided therebetween.

7. The optical module according to claim 6, wherein the optical module further comprises a screen bracket provided on the protective cover; and
the screen bracket is provided with a display screen therein.

8. The optical module according to claim 7, further comprises a second lens and a second bracket, wherein the second lens is provided in the second bracket, and the second bracket is fixedly provided at an end of the lens barrel away from the screen bracket.

9. The optical module according to claim 8, further comprises a third lens fixedly provided in the lens barrel and located on a side close to the screen bracket, and the first lens is movably provided between the second lens and the third lens.

10. The optical module according to claim 9, wherein the second lens, the first lens, and the third lens are arranged sequentially at intervals along an axial direction of the lens barrel; wherein the second lens is a beveled lens, and a beveled edge side of the second lens corresponds to a beveled edge side of the first lens.

11. The optical module according to claim 6, wherein the driving member comprises a bevel gear and a compound gear;
the compound gear comprises a first linkage gear and a second linkage gear, which are coaxially provided; wherein the first linkage gear comprises a conical gear;
the bevel gear is engaged in a meshing transmission with the first linkage gear; and
the second linkage gear is engaged in a meshing transmission with the arc-shaped rack.

12. The optical module according to claim 1, wherein the optical module has a back focal length (BFL) of 2 mm to 5 mm.

13. A wearable device, comprising:
a housing; and
at least one optical module according to claim 1, the optical module being provided in the housing.

14. The wearable device according to claim 13, wherein the housing comprises a spectacle frame which is provided with two lens frames, the optical module is provided as two, and two optical modules are respectively provided in the two lens frames.
